(19) United States
(12) Patent Application Publication
(10) Pub. No.: US 2025/0335934 A1
(43) Pub. Date: Oct. 30, 2025

(54) ITEM ANTI-COUNTERFEITING METHOD

(71) Applicant: BrandsGuards Technology Co., Ltd., New Taipei City (TW)

(72) Inventor: KUO-SHEN LIU, New Taipei City (TW)

(21) Appl. No.: 18/650,119

(22) Filed: Apr. 30, 2024

(51) Int. Cl. G06Q 30/018; G06F 16/955; G06K 19/06

(52) U.S. Cl. CPC G06Q 30/0185; G06F 16/9554; G06K 19/06037

(57) ABSTRACT

The item anti-counterfeiting method is implemented in a management server and in an anti-counterfeiting App in a smartphone. The method includes the following steps: scanning a QR code label or an NFC label printed with QR code affixed to an item and obtaining a QR code and protocol information; transmitting the QR code and protocol information to the management server; converting the QR code and protocol information to a URL pointing to a webpage; transmitting the URL back to the smartphone by the management server and prompting a browser on the smartphone to open the webpage, where the webpage provides an explanatory text to direct a user to verify whether a domain name displayed by the browser is correct, and an instruction text to direct the user to invoke the anti-counterfeiting App after verifying that the domain name is correct; and performing anti-counterfeiting authentication by the anti-counterfeiting App.

### BACKGROUND OF THE INVENTION

### (a) Technical Field of the Invention

The present invention generally relates to anti-counterfeiting measures, and more particularly to an anti-counterfeiting method which leverages the uniqueness of domain names associated with anti-counterfeiters' web sites to ensure the authenticity of items such as products.

### (b) Description of the Prior Art

Well-known goods or banknotes, documents, and other items are widely known to be counterfeited. Although government agencies and private sectors have some anti-counterfeiting measures, the market is still flooded with various counterfeit goods, fake banknotes, and forged documents, making anti-counterfeiting an important issue. Previously, anti-counterfeiting methods mainly relied on printing and manufacturing techniques. However, the existence of counterfeit banknotes and high-end fake watches on the market indicates that these two methods are ineffective. Since the popularization of smartphones, anti-counterfeiting labels using QR codes (Quick Response codes) and NFC (Near Field Communication) have become prevalent. The information embedded within these labels is not visible, making them seemingly difficult to counterfeit at first glance. Consequently, many anti-counterfeiting companies now apply QR codes and NFC anti-counterfeiting labels to products, allowing users to use their smartphones for verification and to eliminate counterfeiting. However, all efforts have ultimately failed, as the market is still filled with counterfeit products. The reasons for this are explained below:

The current QR code and NFC anti-counterfeiting framework on the market is illustrated in FIG. 1. It involves affixing a QR code label 11 or NFC label 12, along with an NFC chip and antenna 13, onto item 10. The QR code label 11 is covered with a shielding sticker 14 to prevent photographing and copying. When users need to authenticate, they peel off this sticker. The packaging of item 10 contains a logo 15 of the item's manufacturer, the QR code label 11 contains a logo 16 of the anti-counterfeiting company, and the NFC label contains a logo 17 of the anti-counterfeiting company. The anti-counterfeiting company develops a mobile App (application) for users to download onto their smartphones. For Apple phones, the App is downloaded from the App Store, and for Android phones, mostly from the Play Store. As shown in the diagram, the user's smartphone 20 has the downloaded App 21, which displays a logo 25 on the screen. The logos 16, 17, and 25 of the same anti-counterfeiting company should be identical. When the QR code label 11 is read by the smartphone 20's camera, a information 22 is received by the smartphone 20. This information 22 is sent via the network 24 from the smartphone 20's App 21 to the software 31 for identification inside the anti-counterfeiting company's management server 30. If the information 22 is already stored in the management server 30, the management server 30 sends a signal to the smartphone 20 to display the genuine item indication 26. Similarly, when the smartphone 20's App 21 reads the NFC label 12, it receives information 23. This information 23 is sent via the network 24 from the smartphone 20's App 21 to the software 31 for identification inside the anti-counterfeiting company's management server 30. If the information 23 is already stored in the management server 30, it sends a signal to the smartphone 20 to display the genuine item indication 26. If the management server 30 does not have information 22 or 23 in store, it sends a signal to the smartphone 20 to display an indication 27 showing that this is a counterfeit item. At first glance, this seems like an excellent anti-counterfeiting solution. However, the entire system can be counterfeited as well, as explained in FIG. 2.

FIG. 2 depicts a counterfeit item and a counterfeited anti-counterfeiting system. The counterfeit item 10a closely resembles the genuine item 10 in both content and appearance. Its counterfeit logo 15a closely resembles the manufacturer's logo 15. The counterfeit QR code label 11a, NFC label 12a, NFC chip, and antenna 13a all appear identical to the original anti-counterfeiting company's QR code label 11, NFC label 12, NFC chip, and antenna 13. The only difference lies in the information 22a and 23a compared to the original information 22 and 23. In other words, the information inside the QR code and NFC chips is different from the genuine ones. However, since this information is not visible, users cannot perceive the differences. The counterfeit logos 16a and 17a closely resemble the logos 16 and 17, respectively. Inside the smartphone 20, there is a downloaded counterfeit App 21a. Counterfeiters can replicate the software structure of the genuine App 21 entirely. When reading the labels, the counterfeit App 21a sends the counterfeit information 22a and 23a to the counterfeit management server 30a for authentication. The counterfeit App 21a may have a counterfeit logo 25a. Due to the vast number of Apps available on platforms like the Apple Store and Play Store, it is challenging to regulate logo similarities or establish standards for similarity, allowing App owners to change their logos freely. Hence, the counterfeit logo 25a can closely resemble the logo 25. When users read the counterfeit labels 11a and 12a on the counterfeit item, the counterfeit App 21a sends the counterfeit information 22a and 23a to the counterfeit management server 30a, which then signals the smartphone 20 to display the genuine item indication 26. Therefore, users are unable to detect the counterfeit nature of the item and instead believe that the anti-counterfeiting system confirms the authenticity, assuming they have purchased genuine items. Thus, the current method of using smartphones to recognize QR codes and NFC for anti-counterfeiting is ineffective. To date, there hasn't been a better anti-counterfeiting method available on the market. It can also be said that there may not be a truly effective anti-counterfeiting method worldwide.

### SUMMARY OF THE INVENTION

The main objective of the present invention is to address the issues outlined in FIG. 2 by providing a new method for authenticating items. It first directs users' smartphones to a website established by the anti-counterfeiter, utilizing the globally unique nature of domain names to confirm that the smartphone is indeed accessing a website built by the anti-counterfeiter. From this website, users can then open the anti-counterfeiting application App. This ensures that the smartphones only enter the anti-counterfeiter's server and not the server of counterfeiters as depicted in FIG. 2, thereby achieving authentication of items that may be counterfeited.

The item anti-counterfeiting method is implemented in a management server and in an anti-counterfeiting App in a smartphone. The method includes the following steps: scanning a QR code label or an NFC label printed with QR code affixed to an item and obtaining a QR code and protocol information; transmitting the QR code and protocol message to the management server; converting the QR code and protocol information to a URL pointing to a webpage; transmitting the URL back to the smartphone by the management server and prompting a browser on the smartphone to open the webpage, where the webpage provides an explanatory text to direct a user to verify whether a domain name displayed by the browser is correct, and an instruction text to direct the user to invoke the anti-counterfeiting App after verifying that the domain name is correct; and performing anti-counterfeiting authentication by the anti-counterfeiting App. Due to the uniqueness of the domain name worldwide, it can be confirmed that the website is built by the anti-counterfeiter. Therefore, the App opened from this website will only allow information to be sent to the anti-counterfeiter's server for authentication, not to the counterfeiter's server, thus avoiding counterfeiting as described in FIG. 2.

In the aforementioned item anti-counterfeiting method, the label can take various forms of QR code labels, such as standard single-layer QR code labels or double-layer QR code labels. It can also be various shapes of NFC labels with QR codes affixed or printed on the surface. The label bears the logo of the anti-counterfeiter or the manufacturer of the item.

In the aforementioned item anti-counterfeiting method, if the smartphone has not yet downloaded and installed the anti-counterfeiting App, the management server will guide the user through the smartphone screen to download and install the anti-counterfeiting App first.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram showing a conventional anti-counterfeiting framework.

FIG. 2 is a block diagram showing a counterfeited anti-counterfeiting system faking the one shown in FIG. 1.

FIG. 3 depicts the operation flow of the item anti-counterfeiting method of the present invention.

FIGS. 4A and 4B depict a screen displayed on an Android smartphone implementing the item anti-counterfeiting method of the present invention.

FIGS. 4C and 4D illustrate a screen displayed on an Apple smartphone implementing the item anti-counterfeiting method of the present invention.

FIG. 5 depicts the operation flow of the item anti-counterfeiting method of the present invention for counterfeit items with QR codes bearing different content information.

FIG. 6 depicts the operation flow of the item anti-counterfeiting method of the present invention for NFC labels.

FIG. 7 depicts the operation flow of the item anti-counterfeiting method of the present invention for two-layer QR code labels.

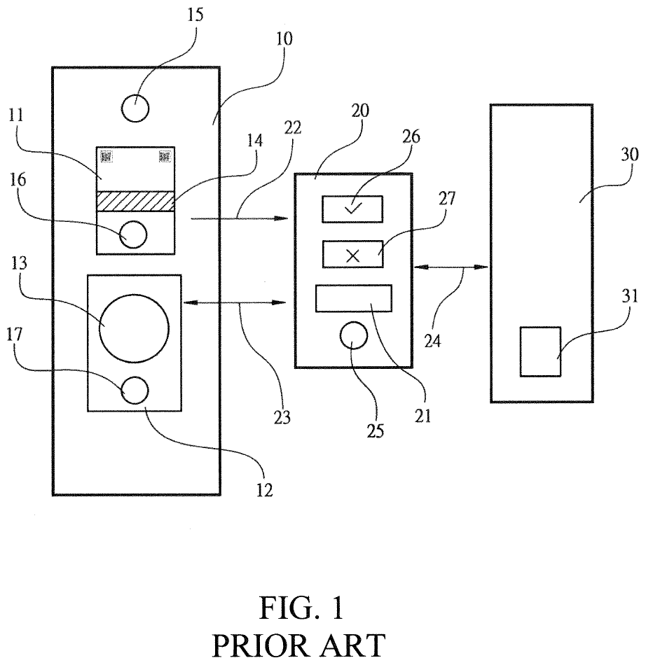

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

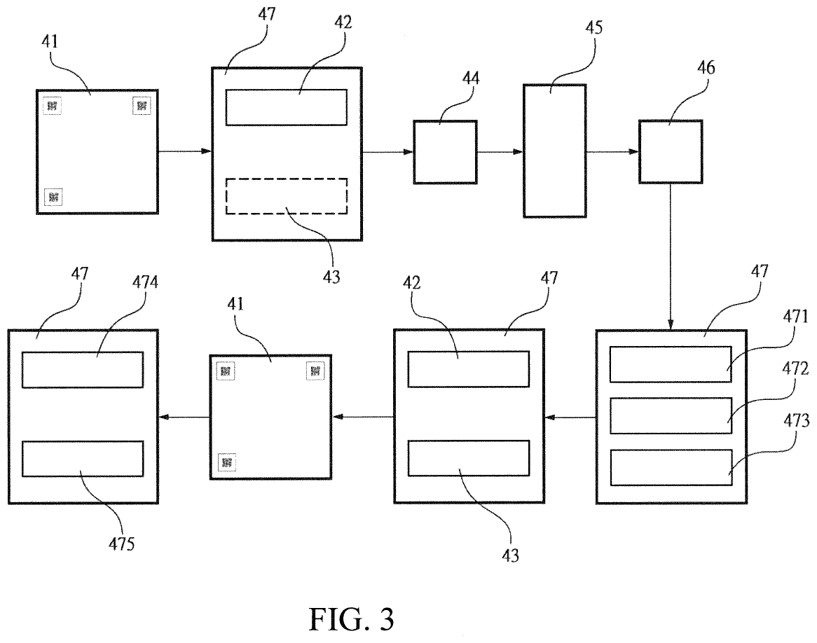

As shown in FIG. 3, an anti-counterfeiting method according to the present invention includes the following steps.

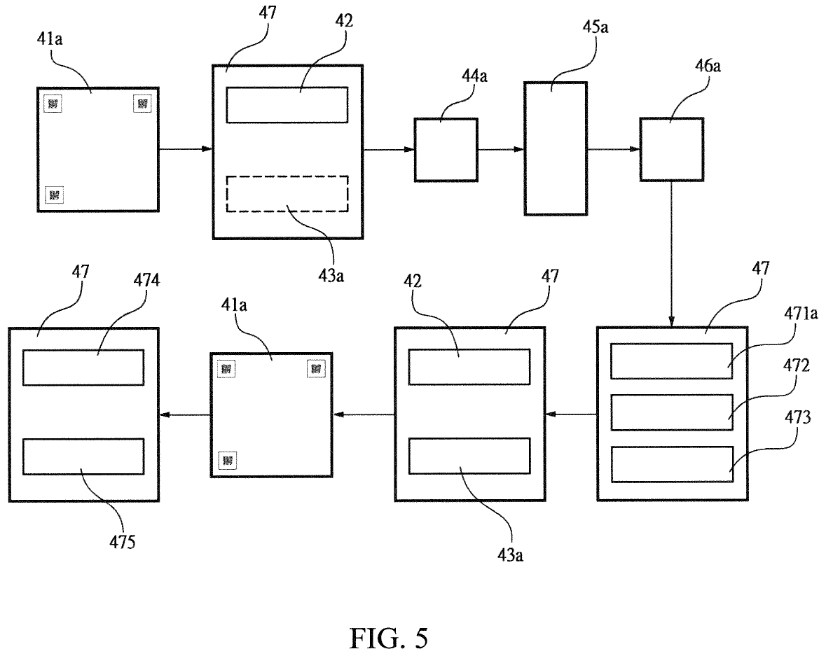

As illustrated in FIG. 3, the anti-counterfeiting method of the present invention comprises the following steps:
1. A QR code label 41 affixed to an item, after the shielding sticker is removed, is scanned through a QR code scanning function 42 of a smartphone 47, and a protocol information 44 is obtained. This protocol information 44 includes, for example, https://ecobill.ccnet.com.tw/api/BrandGuard_qr_new.php?QRcode=A75080118945169 41. A prefix part of the information 44, i.e. https://ecobill.ccnet.com.tw/, serves as a link to a management server 45. The QR code and protocol information 44 are then transmitted to the management server 45 via a network.
2. At this point, an anti-counterfeiting App 43 is already installed but has not yet been activated on the smartphone 47 (represented by dashed lines in the figure).
3. A software on the management server 45 converts the QR code and protocol information 44 into a Uniform Resource Locator (URL) 46, for example https://qr-nfc.com. This URL is then transmitted to the smartphone 47, prompting its browser to open and display the webpage associated with this URL. The webpage will consistently include a domain name 471 (for example https://qr-nfc.com), explanatory text 472, and a image 473. The explanatory text 472 directs a user to verify the domain name 471. On Android smartphones, this domain name is typically displayed at the top of the screen, while on Apple smartphones, it is displayed at the bottom. If the domain name is incorrect, the item is deemed counterfeit, which is the main concept of the present invention. Further elaboration will be provided below along with FIG. 5.
4. If the domain name is correct, the user will be guided based on the displayed instruction text 472 to tap the image 473 which should be same as the tag sticked on the item and then proceed into the anti-counterfeiting App 43. If the smartphone 47 has not yet installed the anti-counterfeiting App 43, the management server 45 will guide the smartphone 47 through the process of downloading and installing the anti-counterfeiting App 43 via the displayed webpage. Once the anti-counterfeiting App 43 is opened, subsequent anti-counterfeiting authentication is performed by utilizing the QR code scanning function 42 within smartphone 47. Scanning the QR code label 41 will display the result of either a genuine item indicator 474 or a counterfeit item indicator 475 on the smartphone 47.

The main content of the present invention has been clarified above, along with FIG. 3. However, in practical applications, due to the distinction between Android and Apple smartphones, adjustments are necessary. Although the domain names displayed on both Android and Apple smartphones may be the same, their display positions and manners differ. In addition to that the anti-counterfeiting App 43 is available from the Play Store for Android operating systems and the App Store for iOS operating systems, the resulting images displayed on screens are also different. On an Android smartphone screen, the domain name always displayed on the above of screen. The IOS smartphone screen, the domain name is either displayed on the above of screen for some models or on the below of screen for other models.

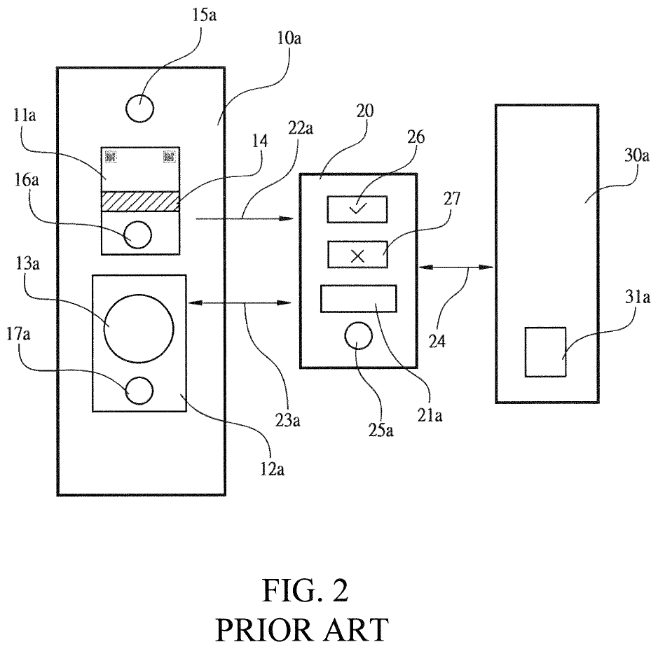

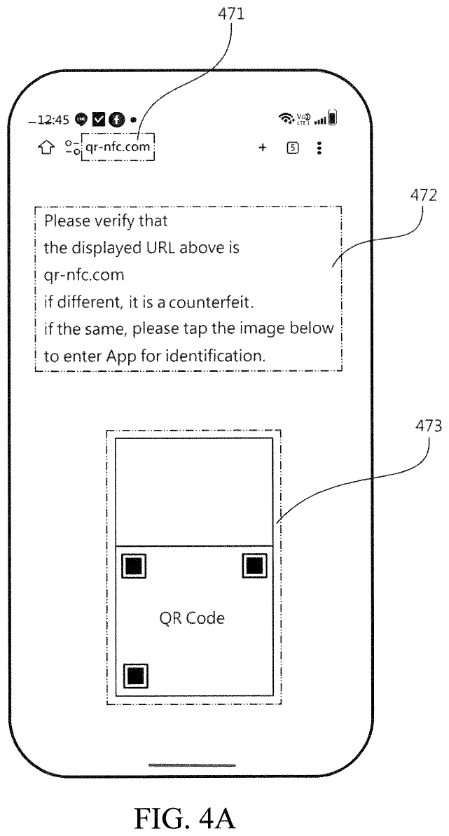

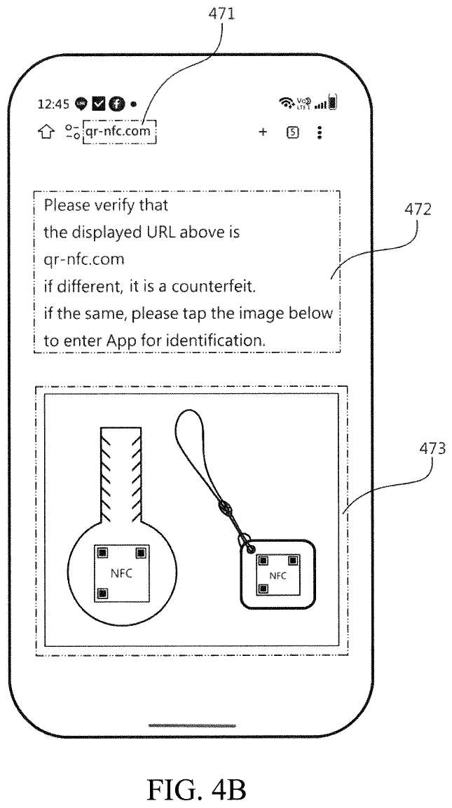

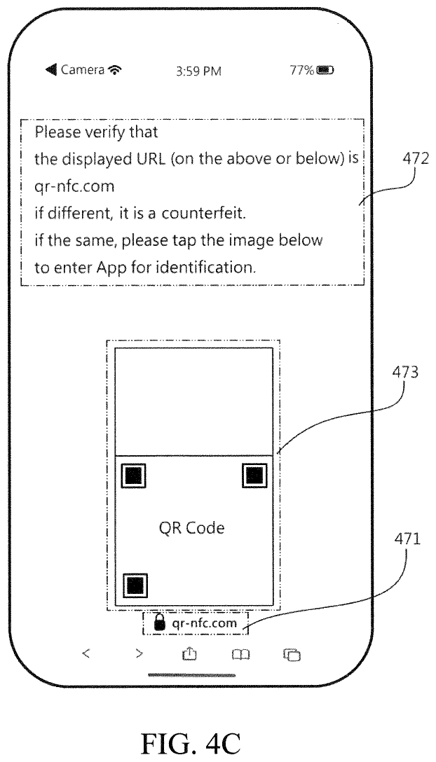

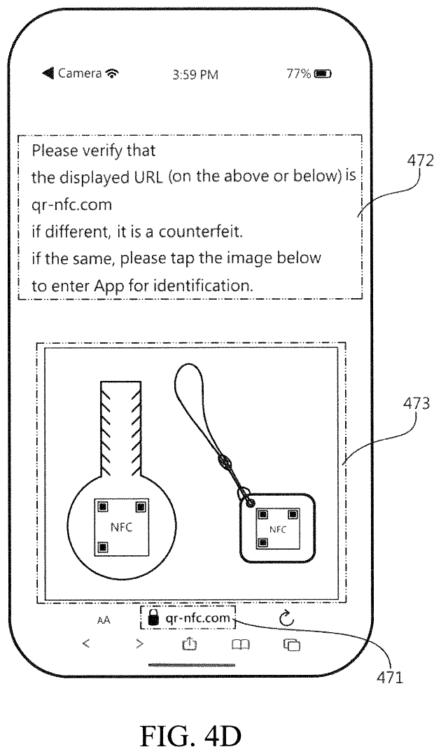

Also the tags have QR code and nfc, Therefore, to ensure that users clearly understand and are guided to see the domain name, the present invention utilizes FIG. 4A, FIG. 4B, FIG. 4C and FIG. 4D to further clarify the contents of the aforementioned domain name 471, explanatory text 472, and image 473. FIG. 4A illustrates a schematic representation of the screen displayed on an Android smartphone, for QR code tag and FIG. 4-2 illustrate for nfc tag, while FIG. 4C illustrates a schematic representation of the screen displayed on an Apple smartphone for QR code tag and FIG. 4-4 illustrate for nfc tag. The QR code and NFC anti-counterfeiting images 473 displayed below are same as the tag sticked on the items.

FIGS. 4A & 4B depict a screen displayed on an Android smartphone when scanning either single-layer or double-layer QR code labels or NFC labels with QR codes printed on them using the camera, which will lead to the execution of the authentication process through the Play Store App. FIGS. 4C & 4D illustrate a screen displayed on an Apple smartphone when scanning either single-layer or double-layer QR code labels or

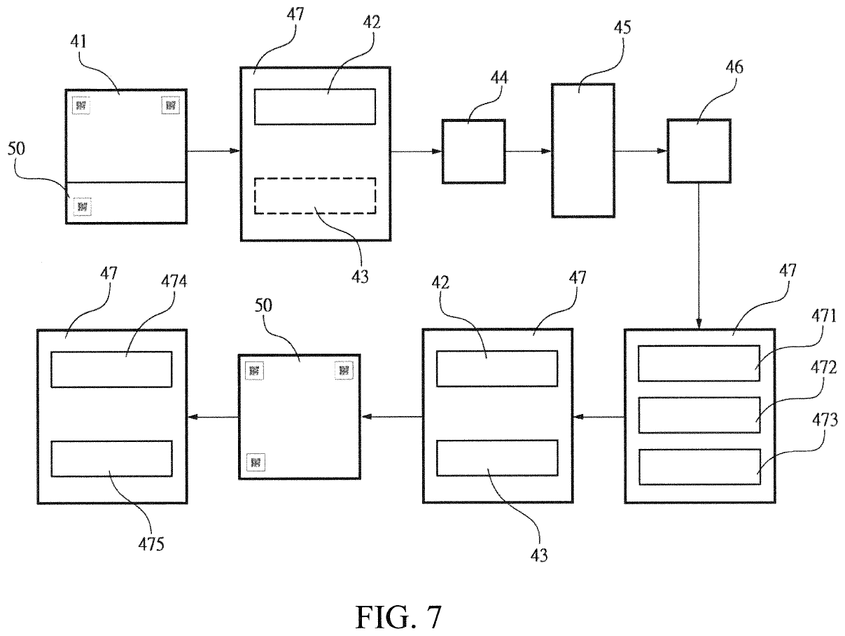

NFC labels with QR codes printed on them using the camera, which will lead to the execution of the authentication process through the App Store App. What are shown respectively in FIGS. 4A˜4D are those that will be displayed realistically. The QR code at the bottom has been changed to a double-layer code for anti-counterfeiting purposes, indicating that the present invention can be applied to various QR code labels, which will be explained below along with FIG. 7.

Actually there are many shapes of QR code and nfc tags and many languages of smartphone, those can be detected by 43 App, to display different explanatory and text 472 and different image 473, so it will be many different situations.

Please refer to FIG. 5, which illustrates the operational flow of the anti-counterfeiting authentication process for counterfeit items with QR codes bearing different content information. As shown in FIGS. 2 and 3, counterfeit items have counterfeit QR codes 41a affixed, bearing different content information. When users' smartphones 47 scan these counterfeit QR codes, they retrieve different counterfeit QR codes and protocol information 44a. These are then processed through the counterfeit management server 45a, which has the capability to redirect information, converting them into counterfeit URL 46a. While counterfeit anti-counterfeiting Apps 43a can be designed to appear identical to the authentic ones, users are completely unaware of their differences. However, when smartphone 47 displays the counterfeit domain name 471a, experienced users will notice the discrepancy between the counterfeit domain name 471a and the original domain name 471, discerning it as counterfeit based on the original explanatory text 472. In normal circumstances, counterfeiters would require at least one year after the genuine item hits the market to produce and counterfeit the anti-counterfeiting devices and create the necessary Apps and server software. During this time, many users would have already used the anti-counterfeiting process of the present invention to recognize the labels bearing logos 15, 16, and 17. Thus, experienced users seeing similar or identical logos 15, 16, and 17 but a domain name 471a different from the original domain name 471 would immediately detect that this is a counterfeit item. Since domain name 471 is unique worldwide, counterfeiters cannot obtain the same domain name. Therefore, their counterfeiting attempts will eventually be detected and eventually prosecuted, eliminating their motivation for counterfeiting.

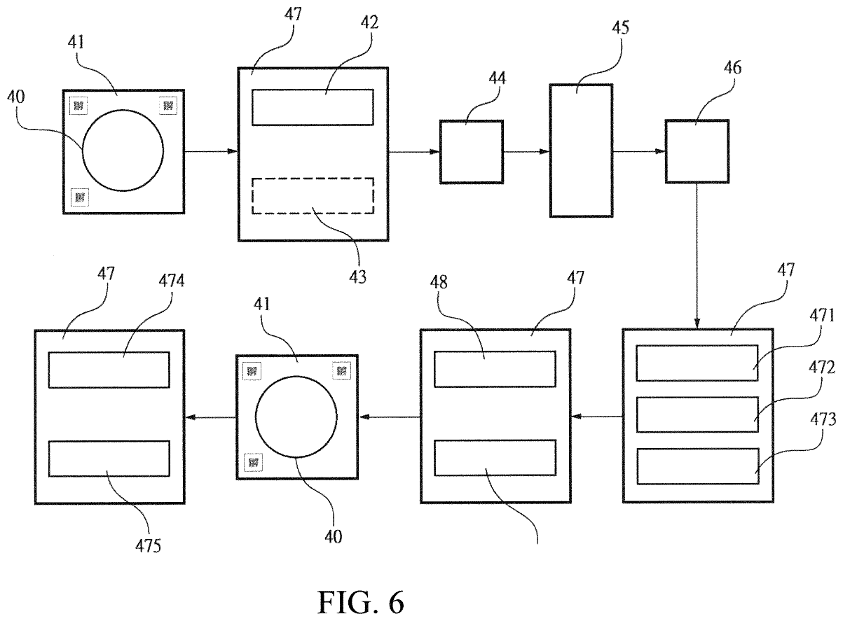

Please refer to FIG. 6, which illustrates the authentication process for the NFC labels of the present invention. As shown, the present invention involves affixing a QR code label 41 identical to those in FIG. 3 onto an NFC chip and antenna 40. The authentication process is similar to that in FIG. 3, guiding users to verify the domain name 471. The main difference lies in a function 48 for reading the NFC. The process consists of at least the following steps:
1. A QR code label 41 is affixed to an item. Through the smartphone 47's camera scanning function 42, a QR code and protocol information 44 are read and obtained. This QR code and protocol information 44 are then sent to the management server 45.
2. The management server 45 converts this QR code and protocol information 44 into an URL 46 and sends it to the smartphone 47 to display the webpage of this URL. The screen will invariably show a domain name 471 and explanatory text 472.
3. If the domain name 471 is correct, the anti-counterfeiting App 43 within smartphone 47 is opened. Then, using the NFC reading function 48 of the anti-counterfeiting App 43, the NFC chip and antenna 40 inside the label 41. This action will result in the display of either a genuine item indicator 474 or a counterfeit item indicator 475 on smartphone 47.

Please refer to FIG. 7, which presents an additional QR code label authentication process introduced by the present invention. As illustrated, the present invention involves affixing a second layer QR code label 50 beneath the original QR code label 41, creating a double-layer QR code label. After verifying the correct domain, the QR code label 41 is removed, and then the QR code label 50 is verified. Because each QR code label carries unique information, the QR code labels 41 and 50 in the double-layer label are paired, making counterfeiting more difficult. Additionally, there is no need for a covering sticker on top of label 41. Therefore, the present invention can be applied with single-layer QR code labels or double-layer QR code labels, as well as NFC labels with QR codes.

In summary, the present invention utilizes an anti-counterfeiting App to enable smartphones to recognize QR codes affixed to items or NFC labels imprinted with QR codes. After reading the QR code on the label, the smartphone sends this information over the network to the management server. The management server then converts this information into the domain name of a website established by the anti-counterfeiter for the smartphone to connect to and display. It also prompts the user to first verify this domain name. Once confirmed by the user, the screen guides them to open the anti-counterfeiting App, thereby executing subsequent anti-counterfeiting authentication of reading QR codes or NFC. Since domain names are globally unique, counterfeiters cannot acquire the same domain name. Thus, any counterfeiting attempt would be identified by users as counterfeit.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. An item anti-counterfeiting method, implemented in a management server and in an anti-counterfeiting App in a smartphone capable of linking with the management server, comprising:
scanning a QR code (Quick Response code) label or an NFC (Near Field Communication) label printed with QR code affixed to an item and obtaining a QR code and protocol information by the smartphone;
transmitting the QR code and protocol information to the management server via a network by the smartphone;
converting the QR code and protocol information to a Uniform Resource Locator (URL) pointing to a webpage;
transmitting the URL back to the smartphone by the management server and prompting a browser on the smartphone to open the webpage, where the webpage provides a text displayed on screen to direct the user to verify whether the domain name displayed by the browser on screen is correct with the text directed, and then to tap an displayed image on screen to direct the user to invoke the anti-counterfeiting App after verifying that the domain name is correct; and
performing anti-counterfeiting authentication by the anti-counterfeiting App.

2. The item anti-counterfeiting method as claimed in claim 1, wherein the instruction text comprises guidance to download and install the anti-counterfeiting App if the anti-counterfeiting App is not yet installed on the smartphone.

3. The item anti-counterfeiting method as claimed in claim 1, wherein scanning the QR code label is through a camera of the smartphone.

4. The item anti-counterfeiting method as claimed in claim 1, wherein the step of performing anti-counterfeiting authentication by the anti-counterfeiting App comprises
scanning the QR code label or reading the NFC label by the anti-counterfeiting App;
performing authentication with the management server; and
displaying a genuine item indicator if authenticated by the management server; otherwise displaying a counterfeit item indicator, on the smartphone.

5. The item anti-counterfeiting method as claimed in claim 1, wherein the QR code label is a single-layer or double-layer QR code.
